(19) United States
(12) Patent Application Publication
(10) Pub. No.: US 2016/0178147 A1
(43) Pub. Date: Jun. 23, 2016

(54) Chandelier for outdoor use

(71) Applicant: MASIERO S.R.L., Frazione Conscio (IT)

(72) Inventor: Enrico Maria Masiero, Treviso (IT)

(73) Assignee: MASIERO S.R.L., Casale sul Sile (IT)

(21) Appl. No.: 14/908,109

(22) PCT Filed: Jul. 29, 2014
(86) PCT No.: PCT/IB2014/063506

§ 371 Date: Jan. 27, 2016

(30) Foreign Application Priority Data
Aug. 2, 2013 (IT) PD2013A000218

(51) Int. Cl. F21S 8/06; F21V 21/02; F21V 23/06; F21V 21/108

(52) U.S. Cl. CPC F21S 8/065; F21V 21/108; F21V 21/02; F21V 23/06; F21W 2131/10

(57) ABSTRACT

A chandelier for outdoor use includes at least one central body for the passage of one or more power supply cables toward a plurality of prewired lamp holder arms that are fixed, by a quick fixing system, to the at least one central body (11) and are connected to it by interlocking connection devices.

The present invention relates to a chandelier for outdoor use.

Currently, installations for daytime and evening open-air events, particularly in locations characterized by a gentle climate, as seaside locations are generally, are increasingly in demand.

For these installations, in terms of lighting accessories, very simple, compact and sturdy lamps are normally used which have a simple geometry and therefore a low visual impact, since it is essential that said lamps can withstand the aggression of atmospheric agents and the action of dust, wind, sand and briny mist in the case of a seaside installation.

These lamps, which have for example a spherical or oval or parallelepipedal shape, have and comprise a body made of transparent plastic material or clear or opalescent glass, for containing the light emitting elements, of the LED, filament, low-consumption or other types.

The electrical components of these lamps are located inside the transparent body itself, or in a fixing base associated therewith, so that said components are protected against adverse weather and the action of dust and sand as well as against the mechanical stresses caused by wind.

The described structural simplicity inevitably entails an appreciable but low visual impact.

Murano chandeliers, i.e., glass chandeliers made by craftsmen, in the 18^{th}-century style that is typical of the island of Murano, are known and appreciated all over the world; said Murano chandeliers have one or more central bodies from which multiple arms extend radially in various ways along curved lines, each one supporting multiple lighting elements and numerous pendants.

However, such a type of chandelier, the lines and shapes of which have been appreciated for centuries all over the world, does not lend itself to be installed in outdoor environments, both due to the delicate nature of the material of which it is made, i.e. glass, and due to the wiring, which necessarily is caused to penetrate to the outside of the glass parts, cleverly concealed, but still can be attacked easily by atmospheric agents.

The aim of the present invention is to provide a chandelier for outdoor use that is strong, easy to assemble and at the same time can have complex shapes that have a high visual impact.

Within the scope of this aim, an object of the invention is to provide a chandelier for outdoor use that is capable of withstanding the aggressive action of adverse weather, of briny mist and of dust, as well as the mechanical stresses caused by wind.

Another object of the invention is to provide a chandelier for outdoor use the wiring of which is protected safely and stably.

Another object of the invention is to provide a chandelier for outdoor use that is modular and therefore can be moved in a compact disassembled configuration.

Another object of the invention is to propose a chandelier for outdoor use that can be manufactured with known systems and technologies.

This aim, as well as these and other objects that will become more apparent hereinafter, are achieved by a chandelier for outdoor use, characterized in that it comprises at least one central body for the passage of one or more power supply cables toward a plurality of prewired lamp holder arms adapted to be fixed, by quick fixing means, and connected electrically, by interlocking connection means, to said at least one central body.

Further characteristics and advantages of the invention will become more apparent from the description of a preferred but not exclusive embodiment of the chandelier for outdoor use according to the invention, illustrated by way of non-limiting example in the accompanying drawings, wherein:

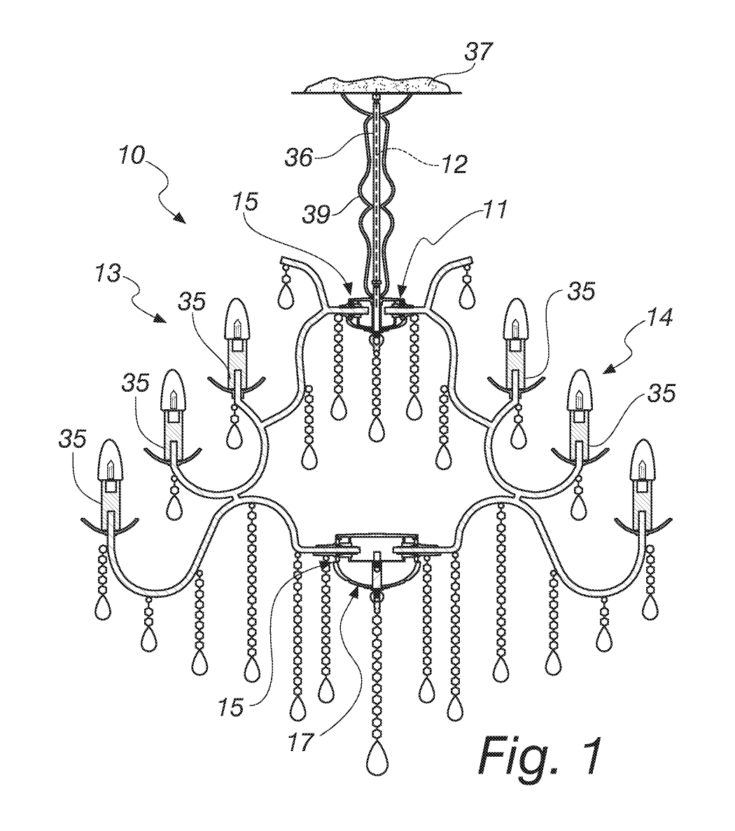

FIG. 1 is a sectional side view of a chandelier according to the invention;

FIG. 2 is an exploded perspective view of a lamp holder arm of a chandelier according to the invention;

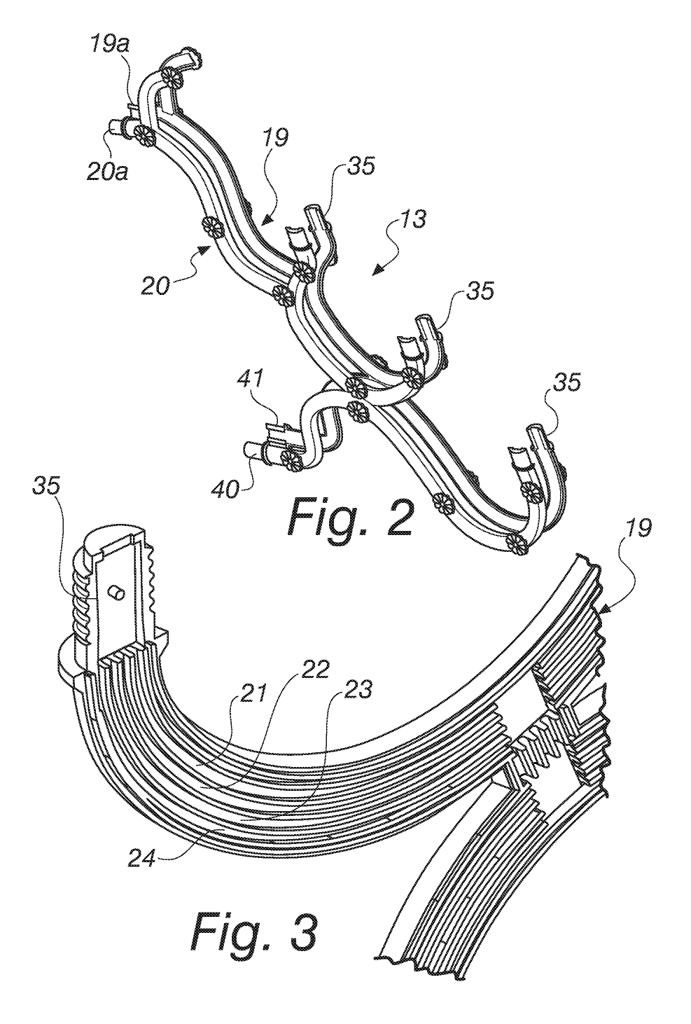

FIG. 3 is a perspective view of a detail of a lamp holder arm of a chandelier according to the invention;

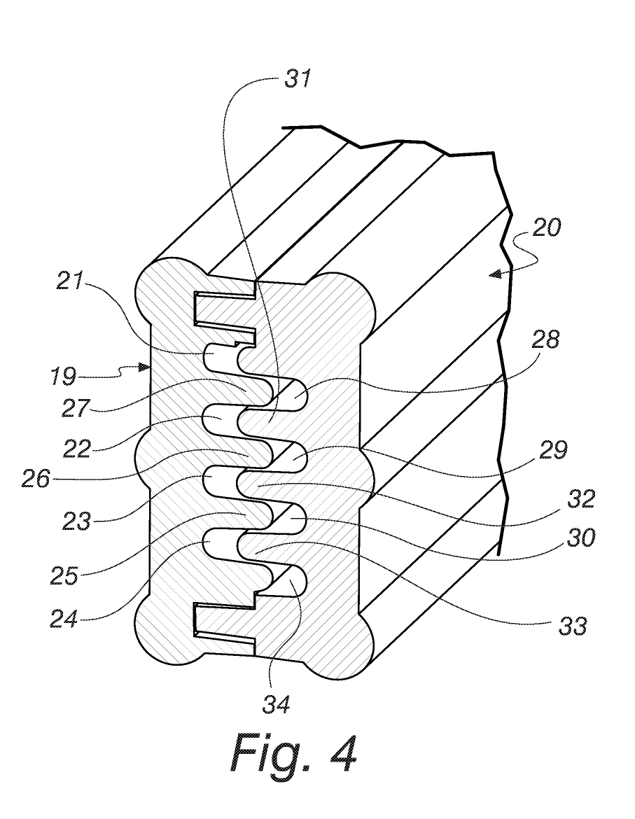

FIG. 4 is a transverse sectional view of a lamp holder arm of a chandelier for outdoor use according to the invention;

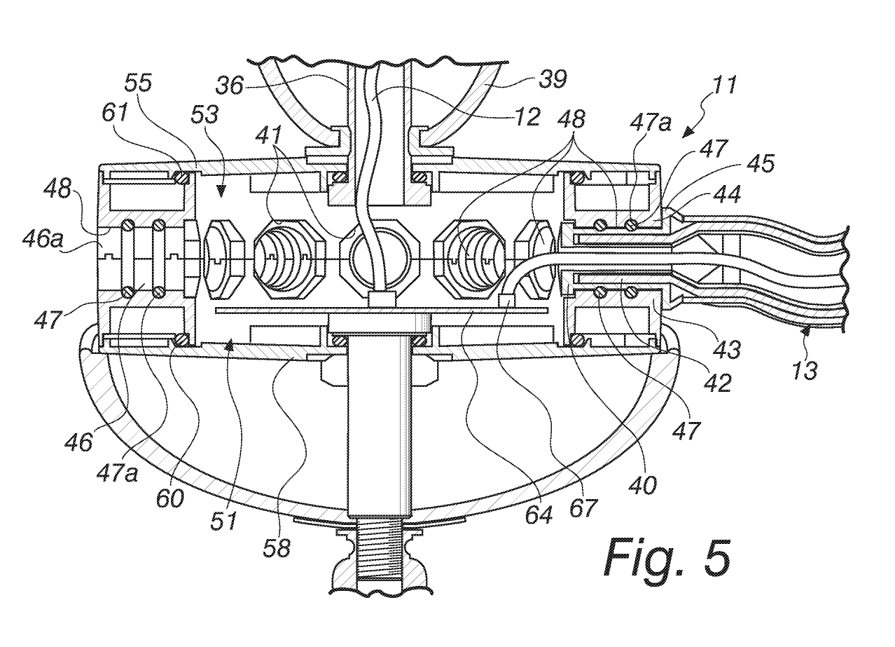

FIG. 5 is a cutout perspective view of a central body of a chandelier for outdoor use according to the invention;

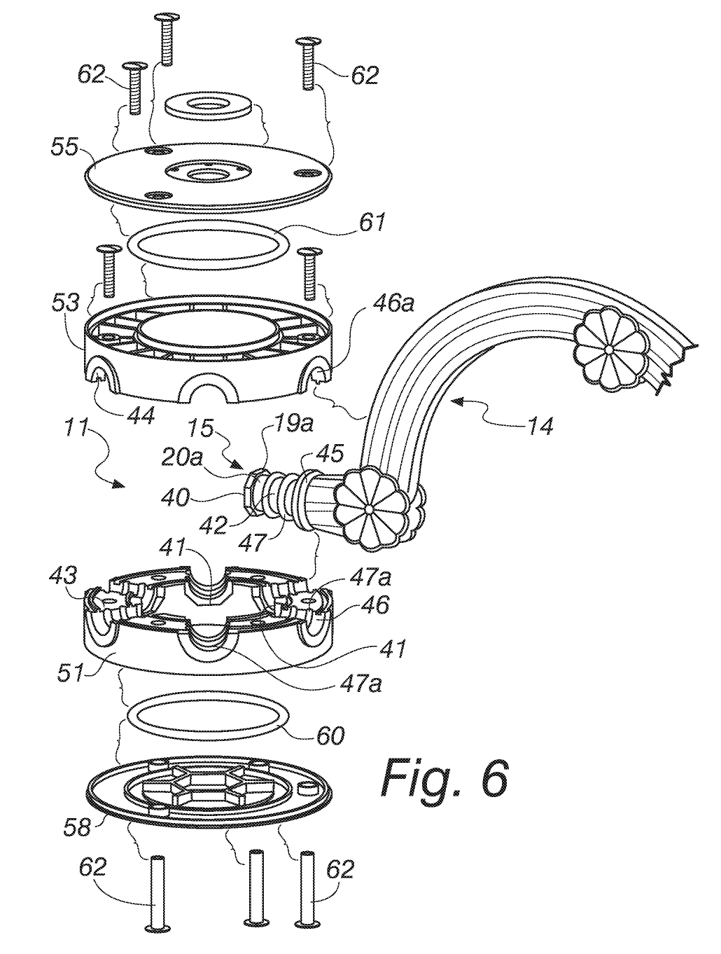

FIG. 6 is an exploded perspective view of an additional central body of the chandelier according to the invention;

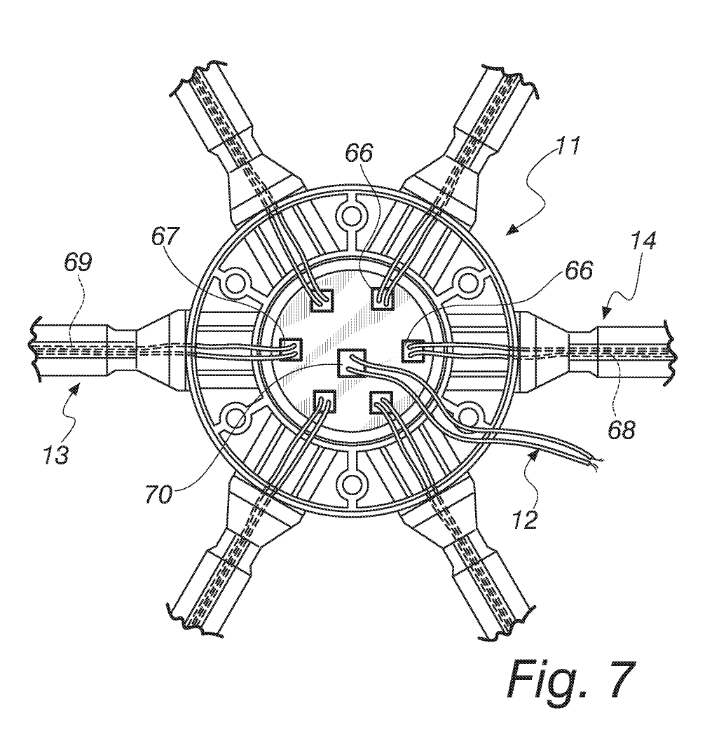

FIG. 7 is a plan view of the central body of FIG. 6, open and with the electrical wiring shown;

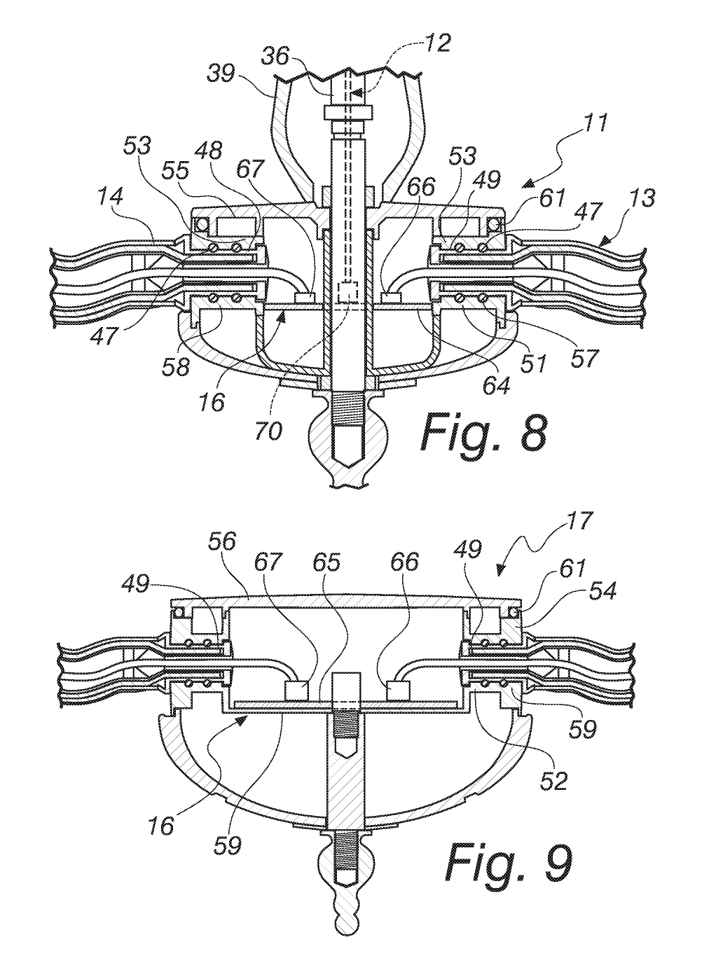

FIG. 8 is a sectional side view of a first central body of the chandelier according to the invention;

FIG. 9 is a sectional side view of a second central body of the chandelier according to the invention.

With reference to the cited figures, a chandelier for outdoor use according to the invention is designated generally by the reference numeral 10.

Said chandelier 10 comprises two central bodies, one of which is a first upper central body (11) for the passage of one or more power supply cables 12 toward a plurality of prewired lamp holder arms, for example 13 and 14 in FIG. 1.

Said prewired arms 13 and 14 are adapted to be fixed to the upper central body 11 by quick fixing means 15, described hereafter, and connected electrically thereto, by interlocking connection means 16, also described hereinafter.

In the constructive example described here, the chandelier 10 comprises two central bodies, an upper first central body 11 and a lower second central body 17.

The second central body 17 is supported by the prewired arms 13 and 14, as shown in FIG. 1.

Said lower second central body 17 supports additional prewired arms, not shown for the sake of simplicity, which are not fixed to the upper first central body 11.

Each prewired arm 13 and 14 is constituted by two half-shells made of plastic material, for example 19 and 20 in FIGS. 2, 3 and 4, which are adapted to be closed onto each other and the closure lines are glued or ultrasound welded or joined by other similar and equivalent means adapted to ensure watertightness of the joint.

On each one of the two half-shells 19 and 20 there is a series of parallel channels, for example 21, 22, 23 and 24 in FIG. 4, in which the wires are to be arranged before closing the two half-shells onto each other.

In an alternative variation, not shown for the sake of simplicity, instead of the series of parallel channels there is a single channel in which bundles or strings of prewired conductors are placed.

The sectional view of FIG. 4 shows how the two half-shells 19 and 20 closed onto each other form between them twice the channels for the wires, by means of the central longitudinal shoulders 25, 26 and 27 of a first half-shell, for example of the first half-shell 19, which are inserted partially in corresponding channels 28, 29 and 30 of the second half-shell 20, and at the same time a corresponding number of central longitudinal shoulders 31, 32 and 33 of the second half-shell 20 are inserted partially in corresponding wiring channels 22, 23 and 24 of the first half-shell 19.

In this manner, the wiring wires in the various wiring channels 21, 22, 23, 24, 28, 29, 30 and 34 are closed stably and in a manner that is safe and protected from the outside.

These eight wiring channels make it possible to install the number of wires that is useful to supply power to the selected lamps, both of the white LED or otherwise monochrome type and of the RGB type.

Each prewired arm 13 and 14 has, for example, three lamp holder couplings 35.

Each prewired arm 13 and 14 is composed of two half-shells 19 and 20 made of transparent plastic material.

The upper central body (11) has a tubular cable guiding element 36 within which the wire the power supply wire or wires 12 descend from the ceiling 37, as shown in FIG. 1.

The wire guiding tubular element 36 can be protected and surrounded by an ornamental tubular element 39, optionally for fixing to the ceiling.

The quick fixing means 15, clearly visible in FIG. 6, are constituted by a wider head 40 for preventing extraction and rotation, which is formed by two symmetrical halves, one on each of two facing ends 19a and 20a of the two half-shells 19, 20 that constitute a prewired arm, for example 14.

Said head 40, with a perimetric profile that is for example octagonal, is adapted to be inserted in a corresponding complementary shaped seat 41 that is formed on the lower part 51 and the upper part 53, respectively, of the upper central body, for example 11 in FIG. 6.

The wider head 40 extends from a sleeve 42 the length of which corresponds to the radial thickness of the walls 43 and 44 of the lower part 51 and the upper part 53 of the central body 11.

Said sleeve 42 is therefore locked between the wider head 40 and a shoulder 45 inside a through hole 48 that is formed by the closure of the two parts, the lower one 51 and the upper one 53, of the upper central body 11, where in each of which a through hole portion, respectively 46 and 46a, is formed.

The sleeve 42 is surrounded by annular sealing elements 47, each intended to enter a corresponding seat 47a formed in the central body 11.

In FIG. 5, the through holes of the upper first central body 11 are designated by the numeral 48.

In the present constructive example, the upper first central body 11 is provided with six radial through coupling holes 48, while the lower second central body 17 is provided with twelve radial through coupling holes 49.

Each central body, both the first one 11 and the second one 17, is composed of a lower part, 51 and 52 respectively, an upper part 53 and 54 respectively, a cover 55 and 56 respectively, and a bottom 58 and 59; the elements are closed onto each other with interposed sealing elements, 60 between the bottom 58 and the lower part 51 and 61 between the upper part 53 and the cover 55 of the upper first central body 11.

The pack formed by the two lower and upper parts, with the cover and the bottom, are fastened to each other by means of a plurality of threaded connections 62 or, as an alternative, by other similar and equivalent fixing means.

The interlocking electrical connection means 16 are constituted, in the present constructive example, by an electronic board 64 or 65, which is fixed within a corresponding central body 11 or 17; said electronic board 64 and 65 is preset to receive the coupling of connectors 66 and 67 that are connected with corresponding electrical cables 68 and 69 for the supply of power of the arms 13 and 14, as in FIG. 7.

The electronic board 64 of the upper central body 11 in turn is wired to a central connector 70 that is connected to the power supply cables 12.

Said quick fixing means 15, together with the interlocking electrical connection means 16, allow the quick and intuitive assembly of the chandelier 10 according to the invention.

Said chandelier 10 with facilitated assembly allows the packaging and shipping of the chandelier in a minimum space occupation configuration, with consequent considerable advantages in terms of shipping and storage costs.

In practice it has been found that the invention achieves the intended aim and objects.

In particular, the invention provides a chandelier for outdoor use that is strong, easy to assemble and at the same time can have complex shapes that have a high visual impact, thanks to the prewired arms made of plastic material, which therefore can be shaped so as to provide the preferred visual impact in compliance with the desired strength characteristics.

In particular, the invention provides a chandelier for outdoor use that is capable of withstanding the aggressive action of adverse weather and of sand and dust as well as the mechanical stresses produced by wind, thanks to the various parts made of plastic material, which are assembled with the interposition of sealing elements that make it possible to provide a degree of protection against water and dust that is standardized as IP65.

The selected plastic material must be such as to withstand the stresses induced by atmospheric agents and such as to withstand corrosion and aging phenomena.

Moreover, the invention provides a chandelier for outdoor use the wiring of which is protected safely and stably; said chandelier can be supplied with power at a very low voltage, 5 V, 12 V, 24 V, in alternating current, with the use of an upstream transformer.

No component of the chandelier is affected by mains voltage; the electrical wiring is built into the various components, and the assembly of the various components, thanks to the interlocking connection means, are easy to provide with a low use of labor, even not particularly skilled labor.

Moreover, the invention provides a chandelier for outdoor use that is modular and therefore can be moved in a disassembled configuration with reduced space occupation.

Last but not least, the invention provides a chandelier for outdoor use that can be manufactured with known systems and technologies.

The invention thus conceived is susceptible of numerous modifications and variations, all of which are within the scope of the accompanying claims; all the details may furthermore be replaced with other technically equivalent elements.

In practice, the materials used, so long as they are compatible with the specific use, as well as the contingent shapes and dimensions, may be any according to the requirements and the state of the art.

The disclosures in Italian Patent Application no. PD2013A000218, from which this application claims priority, are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

The invention claimed is:

1.-10. (canceled)

11. A chandelier (10) for outdoor use, comprising:
a central body (11) adapted for passage of one or more power supply cables (12) toward a plurality of prewired lamp holder arms (13, 14),
wherein said lamp holder arms are adapted to be fixed to the central body, by a quick fixing system (15), and connected electrically, by an interlocking connection device (16), to the central body (11),
wherein the prewired lamp holder arms (13, 14) each comprise two half-shells made of a plastic material (19, 20) and adapted to be closed onto each other, and
wherein the half-shells (19, 20) have closure lines that are welded or glued with a liquid-tight seal.

12. The chandelier according to claim 11, wherein the chandelier has two central bodies comprising a first upper central body (11) and a second lower central body (17), the second central body (17) being supported by the prewired lamp holder arms.

13. The chandelier according to claim 12, wherein the second lower central body (17) supports additional prewired arms that are not fixed to the first upper central body (11).

14. The chandelier according to claim 12, wherein the upper central body (11) comprises a tubular cable guiding element (36), inside which a power supply cable or other cables (12) descend from a ceiling (37), the tubular cable guiding element (36) being provided, inside the central upper central body (11), with one or more openings (38) for passage of electrical wires toward the respective interlocking connection devices.

15. The chandelier according to claim 12, wherein the quick fixing system (15) comprises a wider head (40) for preventing extraction and rotation, the wider head having two symmetrical halves, one on each of two facing ends (19a, 20a) of the two half-shells (19, 20) that define a pre-wired arm,
the wider head (40) being adapted to be inserted in a corresponding complementarily shaped seat (41) that is respectively formed on the lower part (51) and upper part (53) of the upper central body (11),
the wider head (40) extending from a sleeve (42), a length of which corresponds to a radial thickness of walls (43, 44) of the lower part (51) and the upper part (53) of the central body (11),
the sleeve (42) being locked, between the wider head (40) and an opposite shoulder (45), within a through hole (48) that is formed by closure of the lower part (51) and the upper part (53) of the central body (11), on each of which there is a through hole portion (46, 46a),
the sleeve (42) being surrounded by annular sealing elements (47), each adapted to enter a corresponding seat (47a) formed in the central body (11).

16. The chandelier according to claim 11, wherein the chandelier has a plurality of parallel channels (21, 22, 23, 24) formed on each of the two half-shells (19, 20), the wires being configured to be arranged in the parallel channels before closing the two half-shells onto each other.

17. The chandelier according to claim 16, wherein the half-shells (19, 20),
when closed onto each other, define between the half-shells twice a number of channels for wires by having central longitudinal shoulders (25, 26, 27) on a first half-shell (19), which are inserted partially in corresponding channels (28, 29, 30) of a second half-shell (20) and further having a corresponding number of central longitudinal shoulders (31, 32, 33) of the second half-shell (20) partially enter corresponding wiring channels (22, 23, 24) of the first half-shell (19).

18. The chandelier according to claim 11, wherein the interlocking electrical connection device (16) comprises an electronic board (64, 65) that is fixed within the central body (11, 17) and is configured to receive a coupling of connectors (66, 67) that are connected to corresponding electric power supply cables (68, 69) of the arms (13, 14).

19. The chandelier according to claim 18, wherein the electronic board (64) is disposed in an upper portion of the central body (11) and is wired with a central connector (70) connected to power supply cables (12).
